(19) United States
(12) Patent Application Publication
(10) Pub. No.: US 2006/0025270 A1
(43) Pub. Date: Feb. 2, 2006

(54) Constantly engaged rotary recliner mechanism

(76) Inventors: Bernardus W. G. van de Geer, Nol (SE); Erik O. Pettersson, Habo (SE)

Correspondence Address: HARNESS, DICKEY & PIERCE, P.L.C., P.O. BOX 828, BLOOMFIELD HILLS, MI, 48303, US

(21) Appl. No.: 10/900,069

(22) Filed: Jul. 27, 2004

(51) Int. Cl. F16H 1/32

(52) U.S. Cl. 475/162

(57) ABSTRACT

A rotary seat recliner mechanism is provided including an inner gear disc, an outer gear disc, and a center gear disc. The inner gear disc has a first toothed recess. The outer gear disc has a second toothed recess. The center gear disc is supported for eccentric rotation between the inner and outer gear discs. The center gear disc includes a first gear portion and a second gear portion. The first gear portion meshingly engages the first toothed recess. The second gear portion meshingly engages the second toothed recess.

### FIELD OF THE INVENTION

The present invention relates generally to an adjustment mechanism and, more particularly, to a constantly engaged rotary adjustment mechanism.

### BACKGROUND OF THE INVENTION

Rotary recliner mechanisms generally include a first rotary member and a second rotary member. Each rotary member has a plurality of teeth adapted to lockingly engage the other teeth to couple the rotary members together. Typically, the first rotary member is mounted to a quadrant for attachment to a seatback. The second rotary member is mounted to a base plate for attachment to a seat base. The rotary recliner mechanism is operable to lock the first rotary member that is connected to the seatback, thereby restricting its rotation.

The rotary recliner mechanism is selectively locked by manipulating one of the rotary members between an engaged position, wherein the first and second rotary members meshingly engage and a disengaged position, wherein one of the rotary members retracts from engagement with the other. Locking rotary recliner mechanisms also may include a device, such as a spring, for releasably urging one of the rotary members into the engaged position so that the default position for the mechanism is a locked condition. Further, the rotary recliner typically includes an activating mechanism that moves one of the mechanisms between the above-described engaged and disengaged positions.

In reclining seats, the seatback functions as an extremely long lever arm. The locking rotary recliner mechanism is relatively small compared to the length of the reclining seatback. Vehicle vibration or movement of an occupant may impose various forces upon the seatback lever during use. These vibrational forces impose moments on the rotary members that may cause the above-described rotary recliner mechanism to involuntarily disengage.

### SUMMARY OF THE INVENTION

A rotary seat recliner mechanism is provided including an inner gear disc, an outer gear disc, and a center gear disc. The inner gear disc has a first toothed recess. The outer gear disc has a second toothed recess. The center gear disc is supported for eccentric rotation between the inner and outer gear discs. The center gear disc includes a first gear portion and a second gear portion. The first gear portion constantly meshingly engages the first toothed recess. The second gear portion constantly meshingly engages the second toothed recess.

Another aspect of the present invention provides a rotary seat recliner mechanism including an inner gear disc, an outer gear disc, and a center gear disc. The inner gear disc has a first toothed recess. The outer gear disc has a second toothed recess. The center gear disc is disposed between the inner and outer gear discs. The center gear disc includes a first plurality of gear teeth and a second plurality of gear teeth common in number to the first plurality of gear teeth. The first plurality of gear teeth constantly meshingly engage a portion of the first toothed recess. The second plurality of gear teeth constantly meshingly engage a portion of the second toothed recess.

Another aspect of the present invention provides a vehicle seat including a seat bottom, a seatback, and a rotary recliner mechanism. The rotary recliner mechanism includes an inner gear disc, an outer gear disc, and a center disc. The inner gear disc is attached to the seatback and includes a first toothed recess. The outer gear disc is attached to the seat bottom and includes a second toothed recess. The center gear disc is supported between the inner and outer gear discs for eccentric rotation. The center gear disc includes a first gear portion and a second gear portion. The first gear portion is in constant meshing engagement with the first toothed recess. The second gear portion is in constant meshing engagement with the second toothed recess.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention. For example, the rotary adjustment mechanism may be used with a seat tilt gear unit, back restraint gear unit, seat height adjustment gear unit, cab role and roof gear unit, as well as other low RPM gear unit applications.

### BRIEF DESCRIPTION OF THE DRAWINGS

The present invention will become more fully understood from the detailed description and the accompanying drawings, wherein:

FIG. 1 is a side view of a vehicle seat assembly including a rotary seat recliner mechanism;

FIG. 2A is an exploded perspective view of the rotary seat recliner mechanism of FIG. 1;

FIG. 2B is an exploded perspective view of a rotary subassembly of the rotary seat recliner of FIG. 1;

FIG. 3 is a cross-sectional side view of an outer gear disc of the rotary seat recliner mechanism of FIG. 1;

FIG. 4 is a cross-sectional side view of a center gear disc of the rotary seat recliner mechanism of FIG. 1;

FIG. 5 is a cross-sectional side view of an inner gear disc of the rotary seat recliner mechanism of FIG. 1; and

FIG. 6 is a partially assembled plan view of the rotary seat recliner mechanism of FIG. 1 including the outer gear disc, center gear disc, and the rotary subassembly.

### DETAILED DESCRIPTION OF THE PREFERRED EMBODIMENTS

The following description of the preferred embodiments is merely exemplary in nature and is in no way intended to limit the invention, its application, or uses.

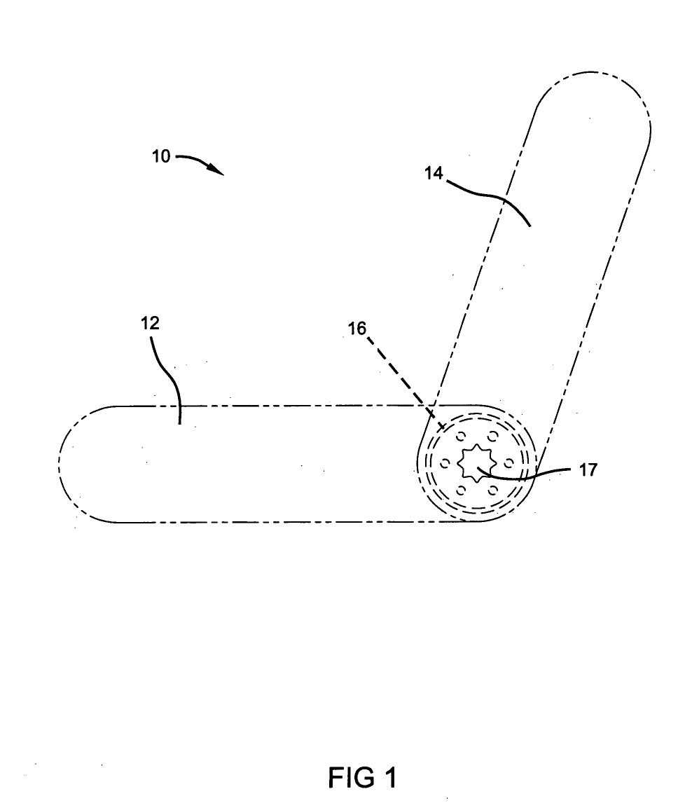

FIG. 1 depicts a vehicle seat assembly 10 including a seat bottom 12, a seatback 14, a rotary recliner mechanism 16, and a handle 17. The handle 17 is rotatably operable to actuate the rotary recliner mechanism 16 and pivot the seatback 14 relative to the seat bottom 12.

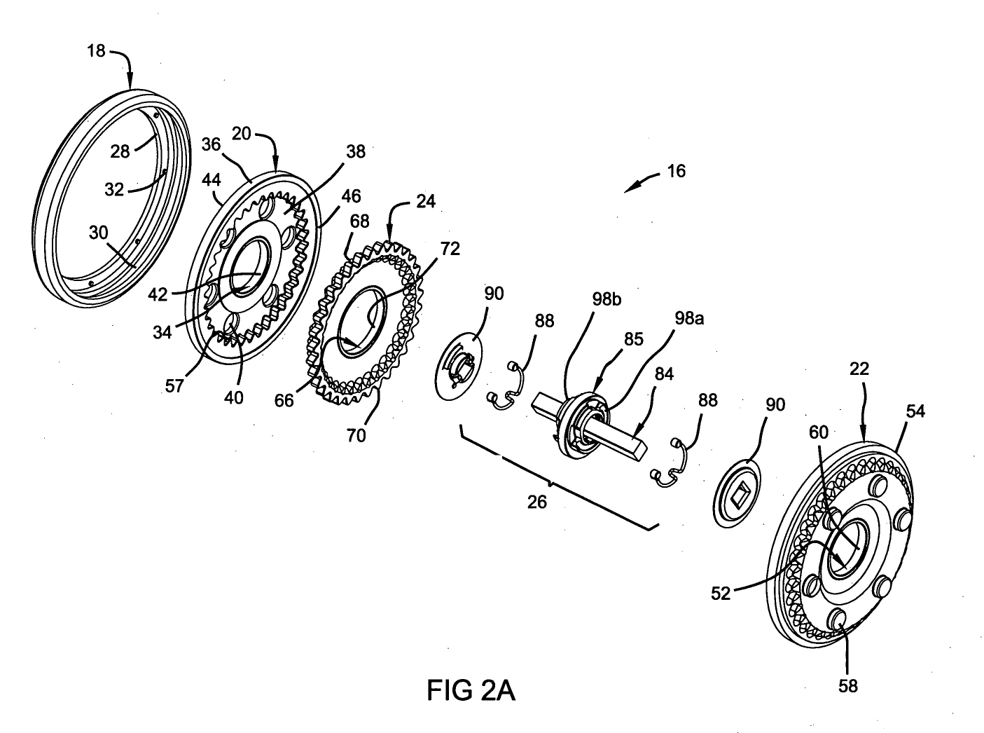

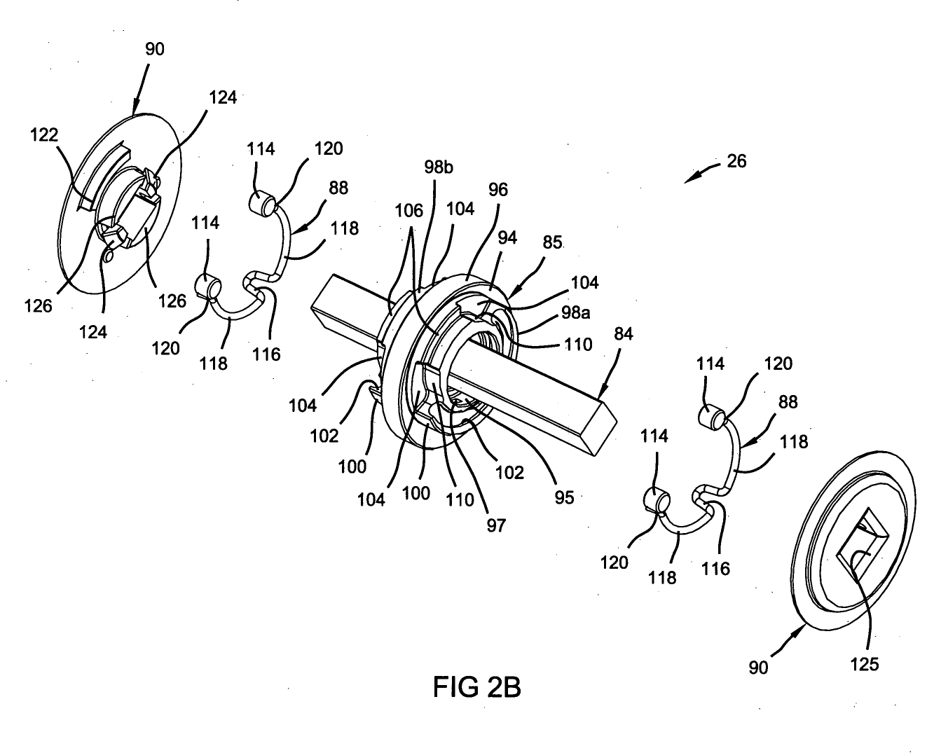

FIGS. 2-6 depict a rotary recliner mechanism 16 including an assembly ring 18, an inner gear disc 20, an outer gear disc 22, a center gear disc 24, and a rotary subassembly 26. The rotary subassembly 26 rotatably supports the inner 20, outer 22, and center 24 gear discs for relative rotation within the assembly ring 18, and functions as an internal locking device to eliminate vibration of the rotary recliner mechanism 16 and/or seat assembly 10.

The assembly ring 18 is a generally annular member including an annular stop collar 28 and an annular channel 30. The annular stop collar 28 includes a plurality of anti-friction bosses 32.

The inner gear disc 20 includes a central aperture 34, a perimeter band 36, a cylindrical recess 38, and a plurality of punches 40. The central aperture 34 includes a cylindrical surface 42. The perimeter band 36 includes an inner axial surface 44 and an outer axial surface 46. The cylindrical recess 38 includes a diameter Dₗ and a plurality of internal teeth 57. The plurality of punches 40 on the inner gear disc 20 are adapted to be pierced by threaded fasteners (not shown) to attach the inner gear disc 20 to the seatback 14.

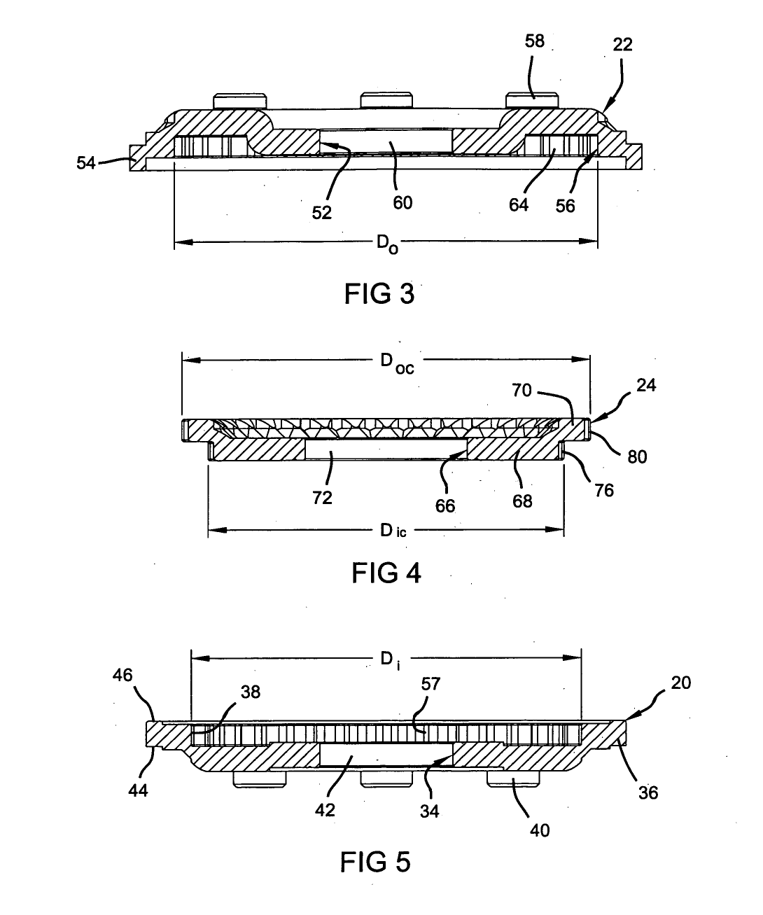

The outer gear disc 22 includes a central aperture 52, a perimeter band 54, a cylindrical recess 56 (seen in FIG. 3), and a plurality of punches 58. The central aperture 52 includes a cylindrical surface 60. The cylindrical recess 56 includes a diameter D₀ and a plurality of internal teeth 64. Similar to the plurality of punches 40 on the inner gear disc 20, the plurality of punches 58 on the outer gear disc 22 are adapted to be pierced by a plurality of fasteners (not shown) to attach the outer gear disc 22 to the seat bottom 12.

The center gear disc 24 includes a central aperture 66, an inner gear portion 68, and an outer gear portion 70. The central aperture 66 includes a cylindrical surface 72. As illustrated in FIG. 3, the inner gear portion 68 includes a diameter D_{Ic} and a plurality of external teeth 76. The outer gear portion 70 includes a diameter D_{OC} and a plurality of external teeth 80.

The inner axial surface 44 of the perimeter band 36 on the inner gear disc 20 slidably rotationally engages the plurality of anti-friction bosses 32 on the annular stop collar 28 of the assembly ring 18. The perimeter band 54 of the outer gear disc 22 is slidably rotationally disposed within the annular channel 30 of the assembly ring 18. The center gear disc 24 is disposed between the inner and outer gear discs 20, 22. The annular channel 30 of the assembly ring 18 maintains the axial disposition of the gear discs 20, 22, 24 within the assembly ring 18.

The cylindrical recess 38 of the inner gear disc 20 receives the inner gear portion 68 of the center gear disc 24. The plurality of external teeth 76 on the inner gear portion 68 of the center gear disc 24 constantly meshingly engage a portion of the plurality of internal teeth 57 in the cylindrical recess 38 of the inner gear disc 20. Similarly, the cylindrical recess 56 in the outer gear disc 22 receives the outer gear portion 70 of the center gear disc 24. The plurality of external teeth 80 on the outer gear portion 70 of the center gear disc 24 constantly meshingly engage a portion of the plurality of internal teeth 64 in the cylindrical recess 56 of the outer gear disc 22.

In an exemplary embodiment, the plurality of internal teeth 64 in the cylindrical recess 56 of the outer gear disc 22 are less than the plurality of internal teeth 57 in the cylindrical recess 38 on the inner gear disc 20. For example, in the embodiment illustrated, the plurality of internal teeth 64 on the outer gear disc 22 includes thirty-five gear teeth. The number of internal teeth 57 on the inner gear disc 20 includes thirty-six gear teeth. The plurality of external teeth 76 on the inner gear portion 68 of the center gear disc 24 is equal to the number of external teeth 80 on the outer gear portion 70 of the center gear disc 24. In the embodiment illustrated, the pluralities of external teeth 80, 76 each include thirty-three gear teeth. This provides for a gear ratio of approximately 36:1 between the inner gear disc 20 and the outer gear disc 22 upon actuation of the recliner mechanism 16, which will be described in more detail below.

It should be appreciated that the constant meshing engagement between the pluralities of teeth, as described above, provides torque and strength to prevent the seatback 14 from involuntarily pivoting relative to the seat bottom 12. However, it should also be appreciated that the rotary recliner mechanism 16 may be adjusted to achieve greater strength and torque capabilities. For example, the diameter of the rotary recliner mechanism 16, the number of pluralities of teeth 57, 64, 76, 80, the depth of the cylindrical recesses 56, 38, the height of the inner and outer gear portions 68, 70 on the center gear disc 24, and the resistance angle between the pluralities of teeth may all be increased to resist greater torques and provide greater strength.

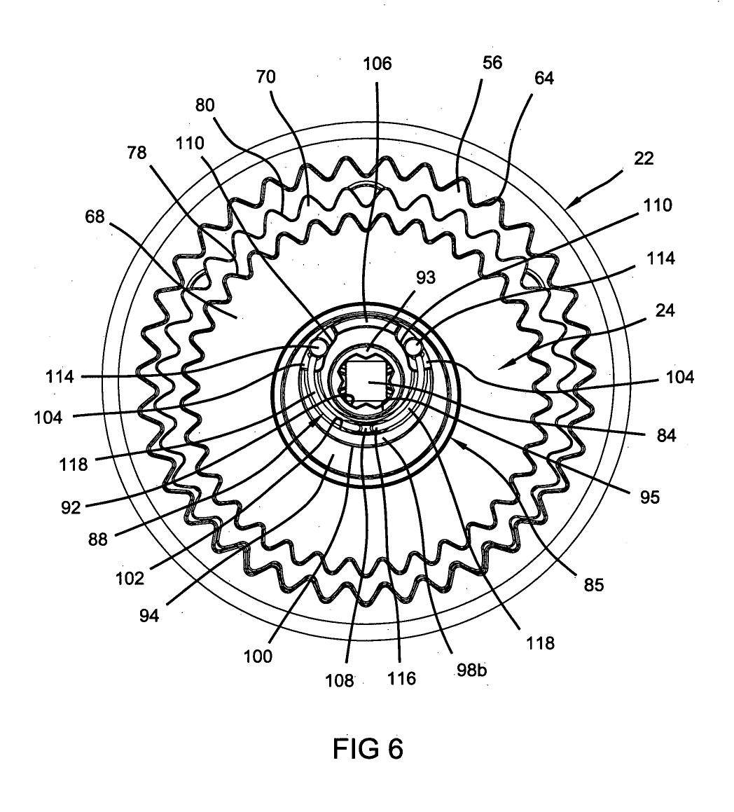

Referring to FIGS. 2A, 2B, and 6, the rotary subassembly 26, which includes a synchronization rod 84, a shaft 85, a pair of bearing rolls 114, a pair of biasing members 88, and a pair of release plates 90, functions as an anti-chuck device to eliminate chucking when the recliner mechanism 16 is not activated. During activation or rotation of the recliner mechanism 16, the rotary subassembly provides free play to permit smooth rotation of the recliner mechanism. The shaft 85 includes first and second center boss portions 98a, 98b and an eccentric ring portion 94. The eccentric ring portion 94 includes a support bore 92 having a generally cross-shaped cross-section defined by a plurality of internal radial arms 93 formed on the shaft 85. The eccentric ring portion 94 also includes a generally cylindrical surface 96. The first and second center boss portions 98a, 98b each include an arcuate surface 100, an annular recess 102, a pair of roll chambers 104, and an arm slot 106. The annular recesses 102 each include an axial pocket 108 shown in FIG. 6 receiving a portions of the biasing members 88. The pair of roll chambers 104 each include radially diverging sidewalls 110. The center boss portions 98a, 98b further include engagement bores 95 in communication with the support bore 92 through the eccentric ring portion 94 of the shaft 85. The engagement bores 95 each include cylindrical sidewalls having a pair of pockets 97 (shown in FIG. 2B) formed therein.

FIGS. 2A and 2B depict the biasing members 88 including a steel member defining a spring portion 116, a pair of arm portions 118, and a pair of hand portions 120. The spring portions 116 of the biasing members 112 are disposed within the axial pockets 108 of the center boss portions 98 of the shaft 85, as illustrated in FIG. 6. The arm portions 118 are disposed in the annular recesses 102 of the boss portions 98. The bearing rolls 114 are disposed within the roll chambers 104 of the center boss portions 98. The release plates 90 each include a release arm 122, a pair of snap flanges 124, a pair of guide flanges 126, and a square aperture 125. The release arm 122 of the release plate 90 is disposed within the arm slot 106 of the center boss portions 98 on the shaft 85. The snap flanges 124 and guide flanges 126 are disposed in the engagement bores 95 of the center boss portions 98a, 98b of the shaft 85. The snap flanges 124 lockingly engage the pockets 97 formed in the cylindrical sidewalls of the engagement bores 95 to secure the release plates 90 to the shaft 85.

The cylindrical surface 72 of the central aperture 66 in the center gear disc 24 slidably rotatably engages the cylindrical surface 96 on the eccentric ring portion 94 of the shaft 85. The cylindrical surface 42 of the central aperture 34 in the inner gear disc 20 slidably rotatably engages the arcuate surface 100 of the second center boss portion 98b on the shaft 85. The cylindrical surface 60 of the central aperture 52 in the outer gear disc 22 slidably rotatably engages the arcuate surface 100 of the first center boss portion 98a on the shaft 85. The synchronization rod 84 is an elongated member having a generally square cross-section disposed through the shaft 85 and the square apertures 125 in the release plates 90.

FIG. 5 depicts the recliner mechanism 16 in an idle position. The spring portions 116 of the biasing members 88 bias the arm portions 118 and hand portions 120 away from the spring portions 116. This causes the hand portions 120 to bias the bearing rolls 114 toward each other. This causes the bearing rolls 114 to travel along the radially diverging sidewalls 110 of the roll chambers 104 and compress against the cylindrical surfaces 42, 60 of the central apertures 34, 52 of the inner and outer gear discs 20, 22. This applies a lateral force to the shaft 85 that causes the arcuate surfaces 100 on the center boss portions 98a, 98b, as well as the cylindrical surface 96 on the eccentric ring portion 94, to frictionally engage the cylindrical surfaces 42, 60, 72 of the central apertures 34, 52, 66 in the inner, outer, and center gear discs 20, 22, 24. This frictional engagement acts to prevent the shaft 85 from rotating therein and secures the recliner mechanism 16 in the position illustrated in FIG. 6.

To actuate the recliner mechanism 16, the synchronization rod 84 must be rotated with the handle 17 (shown in FIG. 1). Upon rotation of the handle 17, the synchronization rod 84 and release plates 90 rotate relative to the inner and outer gear discs 20, 22. This causes the release arms 122 on the release plates 90 to displace in their respective arm slots 106 of the shaft 85. Upon sufficient rotation, the release arms 122 of the opposing release plates 90 simultaneously engage one of the two bearing rolls 114 in each center boss portion 98a, 98b. Which bearing roll 114 is engaged by each release arm 122 is wholly dependent on the rotational direction of the synchronization rod 84 and release plates 90. For example, referring to FIG. 6 and assuming a release plate 90 is attached to the shaft 85, rotating the synchronization rod 84 clockwise causes the release arm 122 to rotate accordingly. Thus, the release arm 122 would engage the right-most bearing roll 114. This causes that bearing roll 114 to travel clockwise and radially inward within the roll chamber 104 along its radially diverging sidewall 110, thereby ceasing to apply the aforementioned lateral force on the shaft 85. This releases the shaft 85 allowing it to generally freely rotate relative to the inner and outer gear discs 20, 22.

Substantially contemporaneously with the aforesaid release, the corners on the square synchronization rod 84 rotationally engage the internal radial arms 93 on the shaft 85. Further rotation of the synchronization rod 84, therefore, rotates the shaft 85. The eccentric ring portion 94 of the shaft 85 eccentrically drives the center gear disc 24 between the inner and outer gear discs 20, 22. This causes the plurality of external teeth 76 on the inner gear portion 68 of the center gear disc 24 to eccentrically rotatably meshingly engage the plurality of internal teeth 57 in the recess 38 of the inner gear plate 20. Simultaneously, the plurality of external teeth 80 on the outer gear portion 70 of the center gear disc 24 to eccentrically rotatably meshingly engage the plurality of internal teeth 64 in the recess 56 of the outer gear plate 22. Due to the above-described diametrical and meshing relationships, the inner gear disc 20 rotates at a predetermined ratio relative to the outer gear disc 22. In the embodiment illustrated and described above, the predetermined gear ratio is approximately 36:1.

The description of the invention is merely exemplary in nature and, thus, variations that do not depart from the gist of the invention are intended to be within the scope of the invention. Such variations are not to be regarded as a departure from the spirit and scope of the invention. For example, the rotary adjustment mechanism may be used with a seat tilt gear unit, back restraint gear unit, seat height adjustment gear unit, cab role and roof gear unit, as well as other low RPM gear unit applications.

What is claimed is:

1. A rotary seat recliner mechanism, comprising:
an inner gear disc having a first toothed recess;
an outer gear disc having a second toothed recess; and
a center gear disc supported for eccentric rotation between said inner and outer gear discs, said center gear disc including a first gear portion meshingly engaging said first toothed recess and a second gear portion meshingly engaging said second toothed recess.

2. The recliner mechanism of claim 1 wherein said first toothed recess includes a first diameter and said second toothed recess includes a second diameter that is larger than said first diameter.

3. The recliner mechanism of claim 1 wherein said first gear portion includes a first diameter and said second gear portion includes a second diameter that is greater than said first diameter.

4. The recliner mechanism of claim 1 wherein said first gear portion and said second gear portion include a common number of gear teeth.

5. The recliner mechanism of claim 1 further comprising a center shaft rotatably supporting said inner gear disc, outer gear disc and center gear disc.

6. The recliner mechanism of claim 5 wherein said center shaft includes a cylindrical shaft portion rotatably supporting said inner and outer gear discs and an eccentric ring portion disposed on said cylindrical shaft portion rotatably supporting said center gear disc.

7. The recliner mechanism of claim 1 further comprising a biasing member attached to said center shaft operable to lock said inner and outer gear discs to said center shaft.

8. The recliner mechanism of claim 6 further comprising a release plate adapted to disengage said biasing member from one of said inner and outer gear discs.

9. The recliner mechanism of claim 1 wherein said first toothed recess includes more gear teeth than said second toothed recess.

10. The recliner mechanism of claim 1 wherein said inner and outer gear discs are supported for relative rotational displacement about a common axis.

11. A rotary seat recliner mechanism, comprising:
an inner gear disc having a first toothed recess;
an outer gear disc having a second toothed recess; and
a center gear disc disposed between said inner and outer gear discs, said center gear disc including a first plurality of gear teeth meshingly engaging a portion of said first toothed recess and a second plurality of gear teeth common in number to said first plurality of teeth meshingly engaging a portion of said second toothed recess.

12. The recliner mechanism of claim 11 wherein said center gear disc is supported on a shaft for eccentric rotation between said inner and outer gear discs.

13. The recliner mechanism of claim 11 wherein said first toothed recess includes a greater number of teeth than said second toothed recess.

14. The recliner mechanism of claim 13 wherein said first toothed recess includes one more tooth than said second toothed recess.

15. The recliner mechanism of claim 11 wherein said first toothed recess includes a first recess diameter that is smaller than a second recess diameter of said second toothed recess.

16. The recliner mechanism of claim 12 wherein said shaft includes a cylindrical shaft portion rotatably supporting said inner and outer gear discs and an eccentric ring portion disposed on said cylindrical shaft portion rotatably supporting said center gear disc.

17. The recliner mechanism of claim 16 further comprising a biasing member attached to said shaft for engaging one of said inner and outer gear discs to rotatably lock said shaft.

18. The recliner mechanism of claim 17 further comprising a release plate adapted to disengage said biasing member from one of said inner and outer gear discs.

19. The recliner mechanism of claim 11 wherein said inner and outer gear discs are supported for relative rotational displacement about a common axis.

20. A vehicle seat, comprising:
a seat bottom;
a seat back; and
a rotary recliner mechanism, including:
an inner gear disc attached to said seat back and including a first toothed recess;
an outer gear disc attached to said seat bottom including a second toothed recess; and
a center gear disc supported between said inner and outer gear disc for eccentric rotation, said center gear disc including a first gear portion in constant meshing engagement with said first toothed recess and a second gear portion in constant meshing engagement with said second toothed recess.

21. The recliner mechanism of claim 20 wherein said first gear portion includes a plurality of gear teeth common in number to said second gear portion.

22. The recliner mechanism of claim 20 wherein sad first gear portion includes a first gear diameter smaller than said second gear portion.

23. The recliner mechanism of claim 20 wherein said first toothed recess includes a diameter smaller than said second toothed recess.

24. The recliner mechanism of claim 20 further comprising a shaft rotatably supporting said inner gear disc, outer gear disc and center gear disc.

25. The recliner mechanism of claim 24 wherein said shaft includes a cylindrical shaft portion rotatably supporting said inner and outer gear discs and an eccentric ring portion disposed on said cylindrical shaft portion rotatably supporting said center gear disc.

26. The recliner mechanism of claim 20 further comprising a biasing member attached to said shaft for engaging one of said inner and outer gear discs to rotatably lock said shaft.

27. The recliner mechanism of claim 26 further comprising a release plate adapted to disengage said biasing member from one of said inner and outer gear discs.

28. The recliner mechanism of claim 20 wherein said inner and outer gear discs are supported for relative rotational displacement about a common axis.
